(19) United States
(12) Patent Application Publication
(10) Pub. No.: US 2007/0294119 A1
(43) Pub. Date: Dec. 20, 2007

(54) System, method and computer program product for evaluating and rating an asset management business and associate investment funds using experiential business process and performance data, and applications thereof

(75) Inventors: Jill Eicher, Glencoe, IL (US); David S. Ruder II, Evanston, IL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Adaptive Alpha, LLC, Chicago, IL (US)

(21) Appl. No.: 11/727,642

(22) Filed: Mar. 27, 2007

Related U.S. Application Data
(60) Provisional application No. 60/787,180, filed on Mar. 30, 2006.

(51) Int. Cl. G06Q 10/00

(52) U.S. Cl. 705/7

(57) ABSTRACT

A method, system and computer program product for evaluating and rating an asset management business and their associated investment funds, including both traditional and alternative managers (i.e., hedge funds) is disclosed. The evaluation of an asset management business and associated investment funds is performed by extracting experiential infrastructure and investment performance data that exists on the computer systems of asset management firms and their outsourced service providers. Experiential infrastructure and investment data includes qualitative and quantitative information compiled or derived from operating systems, databases, applications, electronic files and records that relate to the asset manager's investment and infrastructure performance. Investment and infrastructure performance data also includes transactional and computational records as well as security and portfolio information supporting investment activity and infrastructure business processes. A set of metrics and a series of algorithms is used to measure and rate an asset management business in terms of investment and infrastructure performance. The evaluation and rating method includes: 1) measuring investment and business performance; 2) analyzing and interpreting the measures; 3) putting the results into a contextual framework; and 4) computing an overall rating for an asset management business based on both investment and infrastructure performance.

### CROSS-REFERENCE TO RELATED APPLICATIONS

The present application claims the benefit of U.S. Provisional Patent Application No. 60/787,180 filed on Mar. 30, 2006, titled “System, Method And Computer Program Product For Evaluating An Asset Management Business And Associated Investment Funds Using Experiential Business Process And Performance Data, And Applications Thereof,” which is herein incorporated herein by reference in its entirety.

The present application is related to U.S. Pat. No. 7,136,827 titled “Method For Evaluating A Business Using Experiential Data,” and pending U.S. patent application Ser. No. 11/225,091, filed Sep. 14, 2005, titled “System, Method And Computer Program Product For Evaluating An Asset Management Business Using Experiential Data, And Applications Thereof,” both of which are herein incorporated by reference in their entireties. The present application is also related to “System, Method And Computer Program Product For Evaluating And Rating Counterparty Risk Using Experiential Business Process Performance and Financial Data, And Applications Thereof” filed Mar. 27, 2007 (Attorney Docket No. 2420.0030001), which is herein incorporated by reference in its entirety.

### BACKGROUND OF THE INVENTION

1. Field of the Invention

The present invention is generally directed to rating an asset management business.

2. Background Art

Most businesses can be evaluated by examining the financial statements of the firm and understanding basis customer, supplier, and competitor dynamics. Asset management businesses, however, are different from businesses in general because their success is tied to their ability to assume and mitigate risk.

The asset management industry has experienced significant change in recent years due to disappointing and volatile stock market returns combined with cash and bond yields reaching historic lows. In addition, the migration of investment talent from traditional asset management businesses to alternative investment companies has prompted institutional investors to reassess asset allocation strategies. The hedge fund industry has grown from a cottage industry in the 1980s and early 1990s into an industry that is managing more than $1 trillion in assets in 2006. The unprecedented influx of assets into hedge funds, coupled with a spate of asset manager improprieties and implosions, has created an environment of uncertainty relating to the business practices of asset managers.

With the growth in the asset management industry, institutional investors and government regulators have become concerned about the strength and stability of asset management businesses. Regulators are generally concerned with eliminating fraud and preventing systemic risk to the market. Institutional investors are concerned about meeting their fiduciary duties to their pension plans, endowments, or other asset pools. While investment performance is still important, there is increased concern and scrutiny on asset management businesses.

Many are concerned that asset management businesses have grown too quickly to effectively manage their businesses, placing the assets under management at risk. Asset management businesses are now being evaluated across several dimensions that do not exist for most businesses in general.

While there is a desire to evaluate asset management businesses, it has been problematic due to the shortcomings and limitations of conventional approaches. As a result, investors have limited information to rely upon when hiring or retaining asset managers.

Accordingly, improved approaches for evaluating and rating an asset management business and associated investment funds are desired.

### BRIEF SUMMARY OF THE INVENTION

The present invention is directed to systems, methods and computer program products for evaluating and rating an asset management business and associated investment funds.

As noted above, many are concerned that asset management businesses have grown too quickly to effectively manage their businesses, placing the assets under management at risk. Asset management businesses are now being evaluated across several dimensions that do not exist for most businesses in general.

While there is a desire to evaluate asset management businesses, it has been problematic due to the shortcomings and limitations of conventional approaches. As a result, investors have limited information to rely upon when hiring or retaining asset managers.

As a result, ratings services are beginning to “rate” asset managers similarly to the way they have rated corporations, mutual funds and security instruments. Various constituencies are interested in the ratings of asset managers including: 1) insurance firms underwriting D&O and E&O policies for asset managers, 2) credit providers extending financial leverage to asset managers and hedge funds in particular and 3) investors employing asset managers. The objective in rating asset managers is to facilitate decisions about whether and how to: 1) insure an asset manager; 2) loan capital to an asset manager and/or 3) employ and/or retain an asset manager.

To evaluate asset management businesses, prior art methods use historical investment performance. Typically, historical performance is compared on a current, prior, 3, 5 and 10 year basis. An analysis of historical performance is generally the most widely practiced approach in evaluating the risk and potential of asset managers and their associated funds.

There are four major shortcomings with the reliance on historical investment performance results in current evaluation and rating practices.

First, asset managers “self report” performance to ratings and index service providers. This practice has led to exposure for investors with respect to (i) potential fraud, (ii) undetectable errors, and (iii) inaccurate information being supplied to and used by investors. The United States Securities and Exchange Commission requires registered investment advisors to retain 6 years of transaction data supporting all performance calculations. The present invention includes embodiments that would reduce investor exposure to potential fraud, inaccuracies and misrepresentation by extracting data directly from the asset managers systems and applying automated (and auditable) verification logic to the data and the computational process.

Second, asset managers are evaluated against external benchmarks and artificial peer groups rather than internally set standards and investor objectives. Managers that manage and exceed their own internally set expectations may be seen as poor managers in certain time periods or market conditions when compared against an arbitrary peer group organized by an external ratings group or other intermediary constituencies. This conventional evaluation practice provides perverse incentives for asset managers to become more focused on behaving like their peer group rather than to focus on meeting and exceeding their own internal goals as well as those of their clients. The present invention includes embodiments that evaluate a manager in the context of the representations made by the asset manager to their clients and the objectives set by clients for managers to meet.

Moreover, another embodiment of the present invention establishes a baseline of investment and business performance for an asset management business and deviations from the baseline could be measured, analyzed and interpreted. This would enable an asset management business to be more transparent, better understood and evaluated against its own performance baseline.

A third major shortcoming with the current approach to rating asset managers is the evaluation of the asset manager without any consideration of the infrastructure and operations supporting the business. Evaluation of asset managers is primarily focused on qualitative factors and investment results and neglects the fact that operational and infrastructure issues have and can negatively impact the ability of the asset manager to deliver services to clients. The present invention includes embodiments that include an evaluation of business performance in evaluating and rating an asset management business thereby providing investors with a more comprehensive evaluation than those that rely on investment performance results oriented analyses alone.

Finally, asset manager due diligence is most commonly conducted by subjective methods such as interviews and survey questionnaires. Typically, asset managers complete questionnaires in order to communicate information about their investment practices and businesses both when being considered for employment by investors and on a regular basis as part of the oversight process. These conventional due diligence practices expose investors to (i) potential fraud, (ii) human error on the part of the asset manager, and (iii) human error or fraud on the part of the interviewing party when attempting to understand the nature of the information received. These shortcomings have recently been illustrated by the “blow ups” of Amaranth and Bayou. The present invention includes embodiments that provide investors with an objective and quantitative evaluation methodology of asset management businesses.

In the asset management industry, the data, information and systems available to manage investment portfolios are highly sophisticated, however, there is little in the way of data, information or systems to manage asset management businesses. Prior art methods use investment performance data and analysis thereof as the measure of how well an asset management business is performing and make little attempt to access or incorporate business performance data in their evaluation. This results in a lack of understanding about the business supporting the investment activity and, therefore, the soundness of the asset management firm.

Lacking data, information and systems, the various constituencies of asset management businesses operate with an isolated view and do not have the means to understand the interdependencies between investment and business performance. In addition, they do not have a quantitative framework to evaluate an asset management business as a whole.

An asset management business is best analyzed by its business processes. Understanding the business process of the individual functions and activities within an asset management business can enhance the understanding of the asset management business. This is important for individuals and organizations that select and oversee asset managers in the context of performing their fiduciary responsibilities. Prior art approaches do not operate in this manner.

Many constituencies seek data to understand the strength of an asset management business. These include auditors that seek data on which to base management opinions, and credit providers, that seek to understand the stability of an asset management firm and the potential risks of default on a loan, among others.

Institutional investors and their intermediaries (consultants and fund-of-funds) resort to issuing long due diligence questionnaires to potential and existing managers that they hire. These questionnaires are generally provided in typed documents, and asset managers either type responses or write in responses in long hand. The primary limitation of due diligence questionnaires relates to the self-assessment nature of the practice. As a result, the information does not lend itself well to verification. Additionally, managers respond to the questionnaires on an ad hoc basis and typically delegate their completion to non-investment personnel outside of the business areas being examined.

Accordingly, the present invention provides a system, method and computer program product for rating asset management businesses, such as but not limited to a mutual fund or hedge fund, by extracting investment and business performance data that exists on the computer systems of asset management firms and/or their outsourced service providers to evaluate an asset management business.

Experiential data is data that is produced in the course of operating the business. This includes data generated from both investment activity and business (operating) activity. Experiential business data includes qualitative and quantitative information compiled or derived from operating systems, databases, applications, network infrastructure, electronic files and records that relate to the asset manager's investment and business performance. Investment and business data includes transactional and computational records as well as security and portfolio information supporting investment activity and business processes.

The method includes: 1) the identification and application of previously untapped data from disparate computerized systems supporting asset management businesses; 2) the automated extraction of experiential data for the evaluation of an asset management business (such as a traditional asset manager, mutual fund or hedge fund; 3) the application of a set of metrics and algorithms to the extracted investment and business experiential data to measure, analyze, interpret and ultimately rate an asset management business; and 4) the utilization of both investment performance and business (operating) experiential data in rating an asset management business.

According to an embodiment, a specific set of mathematical functions, referred to as metrics and algorithms, are applied to the collected experiential data to measure, analyze and interpret the investment and business performance of the asset management business. The measures, scores and ratings are expressed as values or graded categories and provide a quantitative framework for understanding an asset management business.

An embodiment of the invention provides two dimensions of analysis and perspective, one related to the investment services provided by the asset management business and the other related to the business services supporting the asset management business. In this way, the present invention provides an understanding of the interdependency of investment and business services and performance.

In the embodiments of the invention, the functions described herein are performed automatically using one or more computers. In other embodiments, some manual intervention is involved in some of the functions described herein. Implementation of these embodiments via software and hardware will be apparent to persons skilled in the art based on teachings contained herein.

These and other advantages and features will become readily apparent in view of the following detailed description of the invention. Note that the Summary and Abstract sections may set forth one or more, but not all exemplary embodiments of the present invention as contemplated by the inventor.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an asset manager rating system according to an embodiment of the invention.

FIG. 2 illustrates operational components of an asset manager rating system according to an embodiment of the invention.

FIG. 3 is a flow chart illustrating a process for rating asset management businesses, according to an embodiment of the invention.

FIGS. 4A-4F are data flow diagrams illustrating the operation of an example embodiment of the invention for rating asset management businesses.

FIG. 5A is an example computer system used to implement embodiments of the invention.

FIG. 5B is an example verification algorithm according to an embodiment of the invention.

FIG. 5C is a block diagram of an example interpretive algorithm system according to an embodiment of the invention.

FIGS. 6 and 7 illustrate other functional views of an asset manager rating system according to embodiments of the invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION OF THE INVENTION

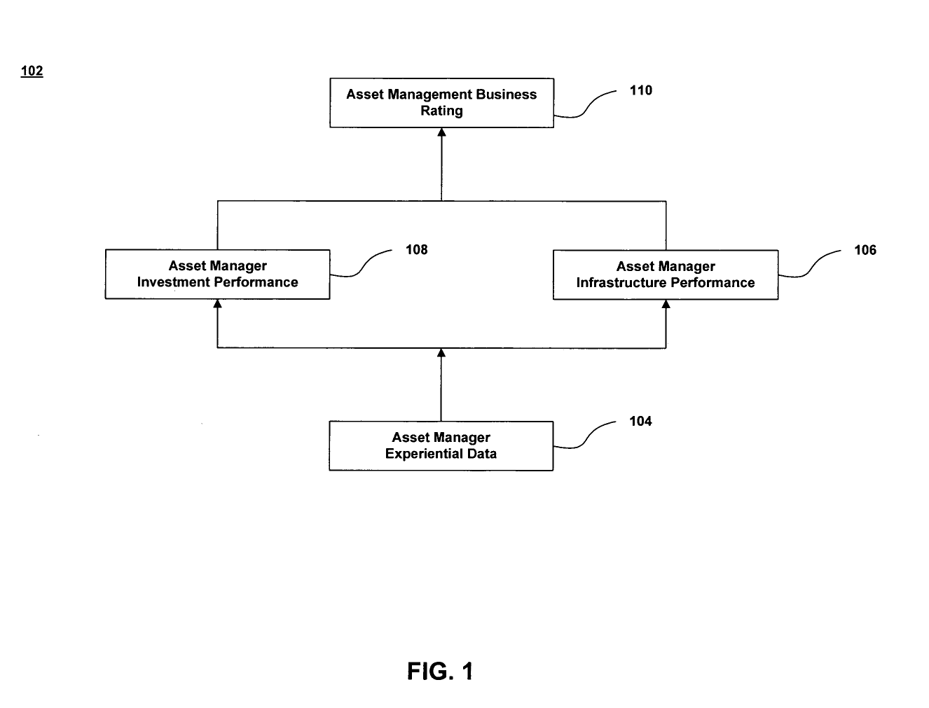

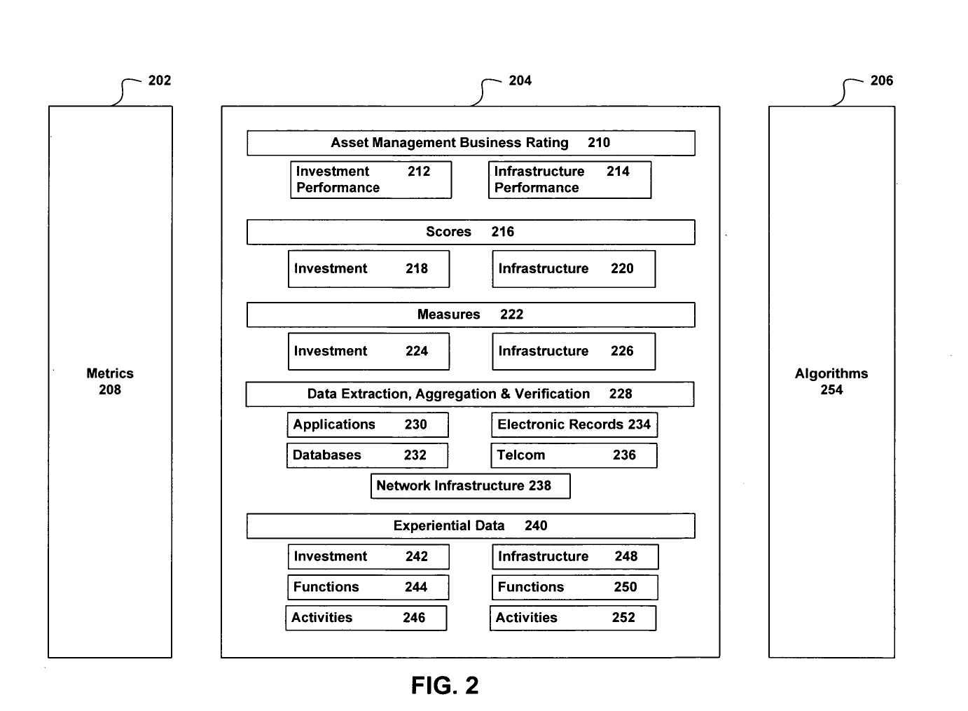

The present invention provides a system, method and computer program product whereby investment and infrastructure data is used to evaluate and rate an asset management business. To do so, the method uses experiential data generated in the course of the investment and infrastructure services (business processes) of an asset management business to fuel specific, predetermined mathematical functions, or metrics and algorithms, to evaluate and rate the asset management business. FIG. 1 illustrates an asset management business rating system 102 according to an embodiment of the invention. The asset management business rating system 102 generally operates as follows. Asset manager experiential data 104 is used to assess asset manager investment performance 108 and asset manager infrastructure performance 106, which are used in turn to determine an asset manager rating 110. FIG. 2 is a block diagram representing the operation of an asset manager rating system 110 according to an embodiment of the present invention.

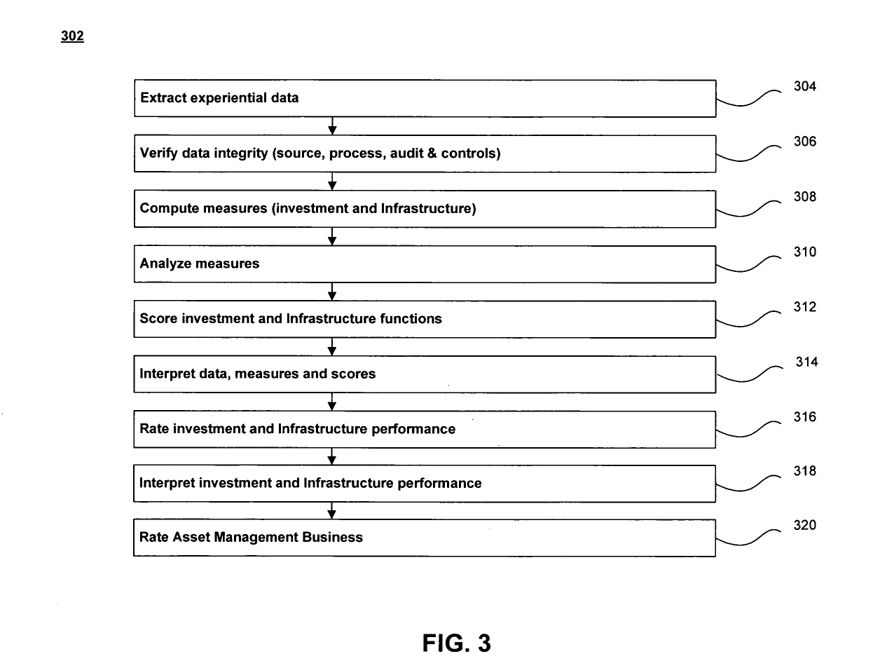

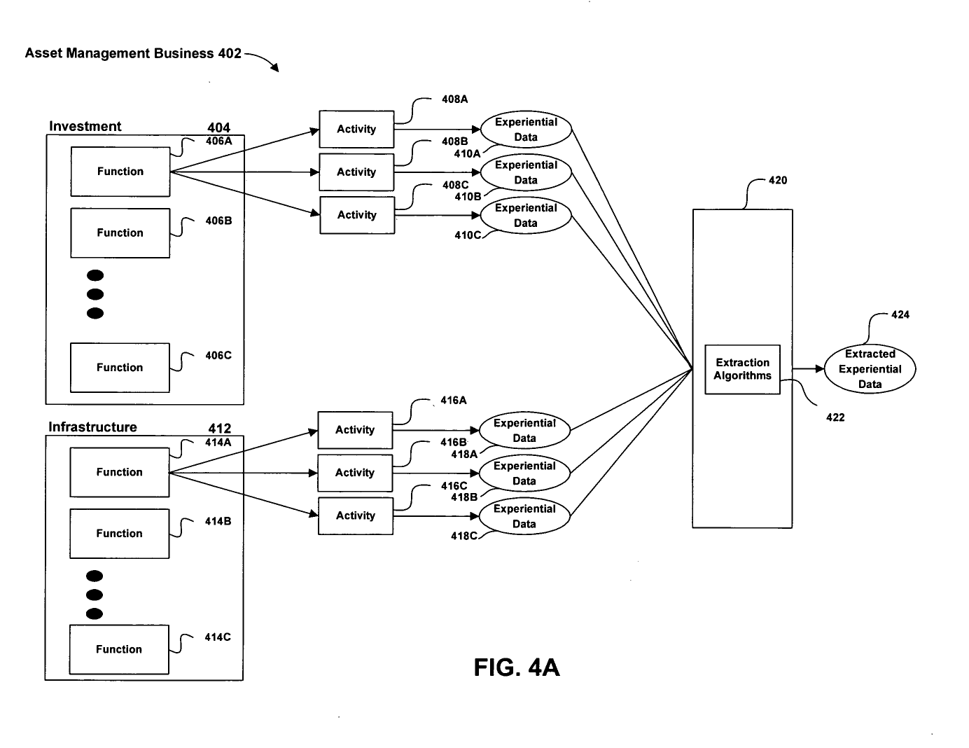

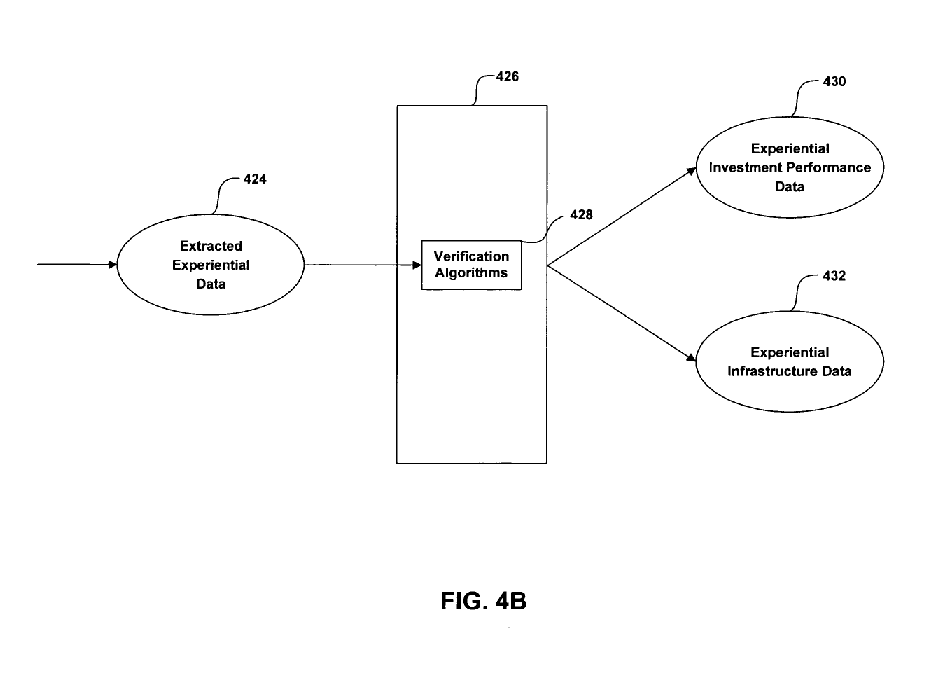

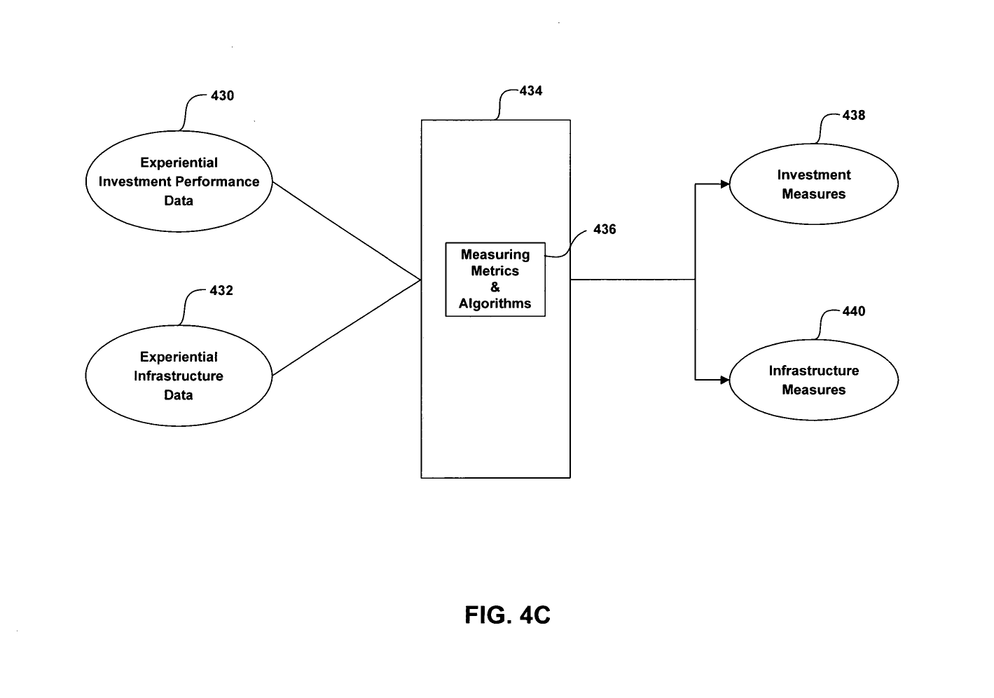

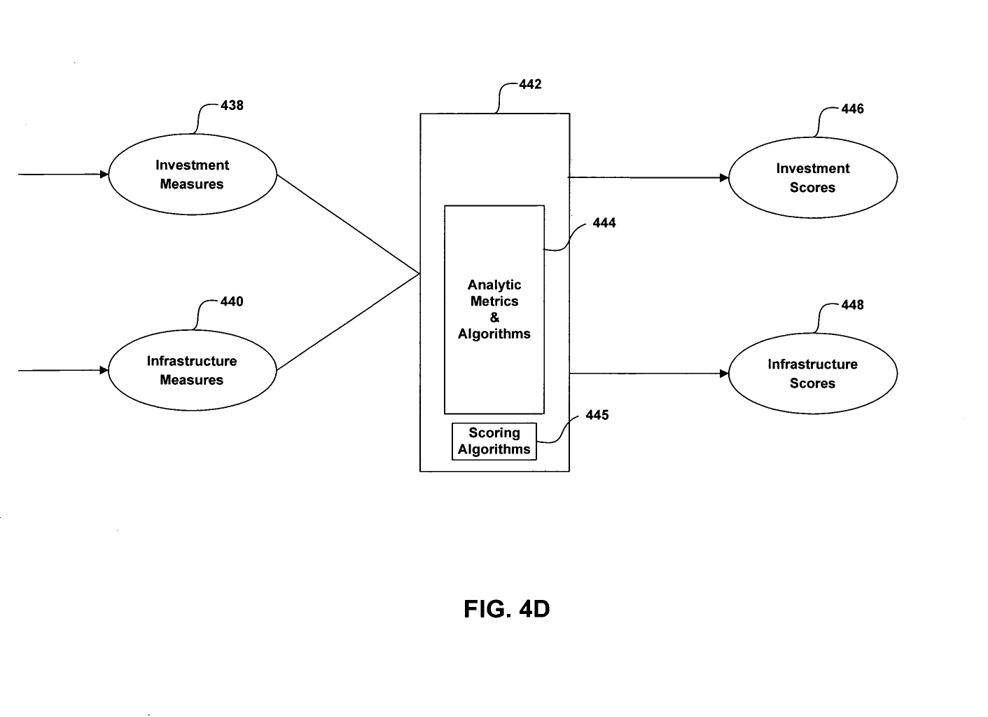

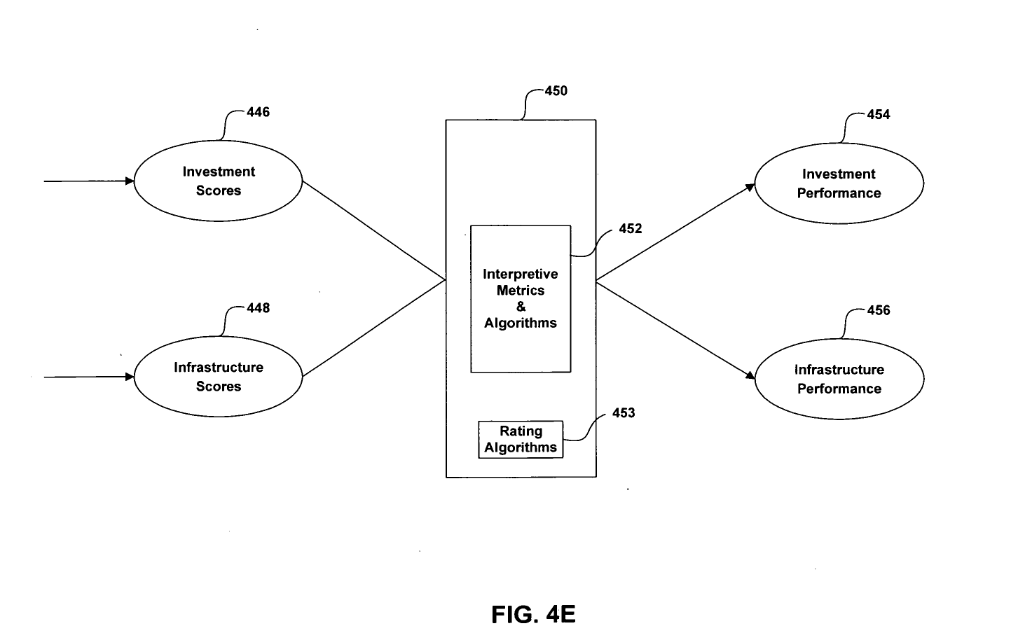

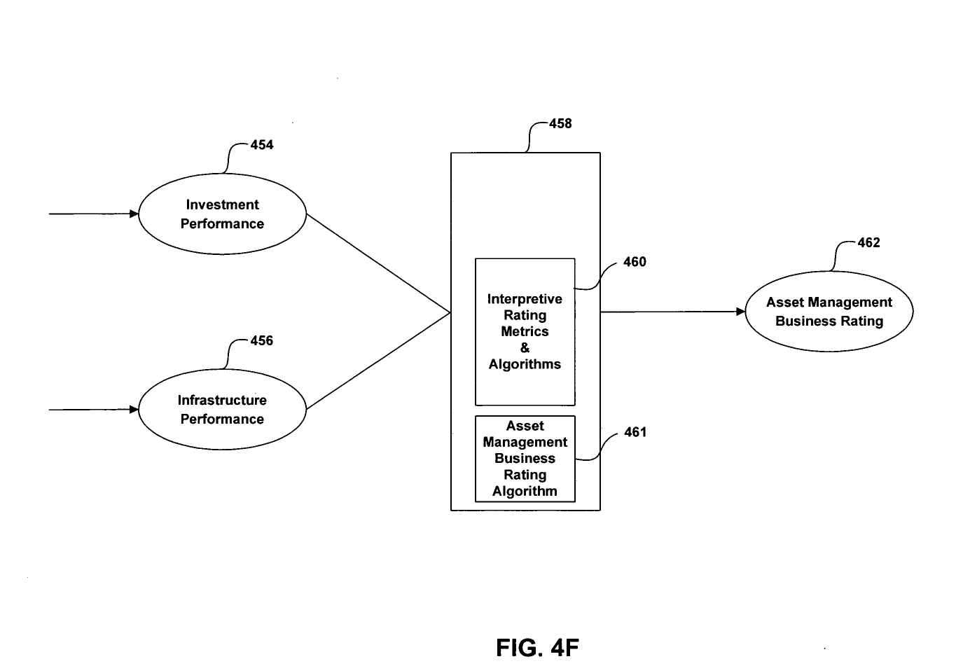

FIG. 3 illustrates a flowchart of the steps of the inventive method for using experiential data generated in the course of investment and infrastructure activities of an asset management business to fuel specific, predetermined mathematical functions, or metrics and algorithms, to evaluate and rate an asset management business, according to an embodiment of the invention. The first step is extracting data (step 304). Data is generated in the course of delivering services to clients. The delivery of services to clients is achieved by performing services (business processes) designed to carry out the requisite functions and activities related to the asset management business. Businesses are often thought of in terms of departments, however, the inventive method organizes an asset management business by function and activity for greater specificity. Within each function is a sub-set of activities that make up the function. This is illustrated in the example data flow diagram of FIGS. 4A-4F. In particular, FIG. 4A illustrates an example business 402. The business 402 is organized according to the functions 406, 414 it performs. Examples of these functions 406, 414 are specified, for example, in Table 1. Each function 406, 414 includes a number of activities 408, 416. An exemplary set of functions and their associated activities are listed in Table 1. These example functions and activities are provided solely for purposes of illustration, and are not limiting.

TABLE 1
Business Organization by Function and Activity

| Investment 404 | Function 406 | Activity 408 |
|---|---|---|
| | Research | Idea generation |
| | | Implementation strategy |
| | Portfolio Management | Investment due diligence |
| | | Strategy & execution |
| | | Investment risk management |
| Infrastructure 412 | Function 414 | Activity 416 |
| | Sales | Market research |
| | | New business |
| | | Prospect development |
| | Client Service | Communications |
| | | Retention |
| | Management/General Partner | Alpha generation |
| | | Business strategy & execution |
| | | Compensation |
| | | Governance & ownership |
| | Treasury | Cash management |
| | | Human resources |
| | | Margin financing |
| | | Securities lending |
| | Compliance | Business risk management |
| | | External compliance |
| | | Internal oversight |
| | Controller | Audit/tax |
| | | Corporate finance |
| | | Portfolio accounting & reconciliation |
| | | Pricing |
| | Operations | Corporate actions |
| | | Portfolio recordkeeping |
| | | Proxy voting |
| | | Trade capture |
| | | Trade error resolution |
| | | Trade settlement |
| | Information Technology | Business continuity |
| | | Data management |
| | | Security |
| | | System administration |
| | | System development |
| | | Web services |

An embodiment of the invention further organizes an asset management business by differentiating between functions and activities related to investing assets 404 and those functions and activities related to running the business 412. Functions and activities are attributed in Table 1 to either investment or infrastructure services (business processes).

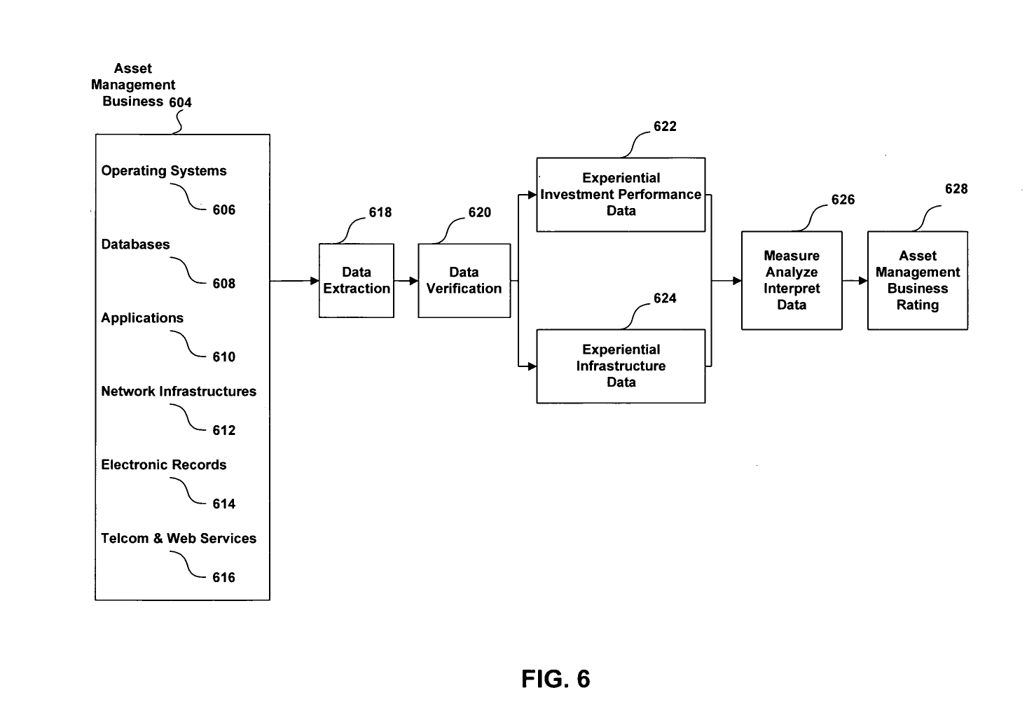

The data is extracted from databases and applications in addition to operating systems, databases, applications, network infrastructure, audit logs, electronic files and records supporting the asset management business. FIG. 6 illustrates example computer systems 606, 608, 610, 612, 614, 616 used in an asset management business 604. FIG. 6 also illustrates the sequence of steps 618, 620, 622, 624, 626, 628 in an embodiment of the inventive method. The operation of these steps will be apparent to persons skilled in the relevant arts based on the teachings contained herein. The most common data available from asset managers comes from databases and applications, however, the data used in the inventive method is not limited to data emanating from databases and applications. Data can be compiled from additional sources such as operating systems, network infrastructure, web services, audit logs, electronic communications, files and records as well as supplied manually. An exemplary set of applications and databases supporting asset management business is listed in Table 2. The example of Table 2 is provided solely for purposes of illustration, and is not limiting.

TABLE 2
Asset Management Business Applications and Database Type

| Applications | Database Types |
|---|---|
| Transaction Processing | Transaction |
| Systems | |
| Analytic | Holdings |
| Portfolio management | Performance |
| Order management | Reference data |
| Trading | Policies & procedures |
| Risk management | Human resource |
| Compliance | Customer relationship |
| Trade allocation, notification | Proprietary or implementation dependent |
| & delivery | |
| Reconciliation | Proprietary or implementation dependent |
| General ledger | Proprietary or implementation dependent |
| Trade capture | Proprietary or implementation dependent |
| Portfolio accounting | Proprietary or implementation dependent |
| Market data, news & utilities | Proprietary or implementation dependent |
| Performance measurement | Proprietary or implementation dependent |
| & attribution | |
| Proxy voting | Proprietary or implementation dependent |
| Corporate action processing | Proprietary or implementation dependent |
| Proprietary or other | Proprietary or implementation dependent |
| applications | |

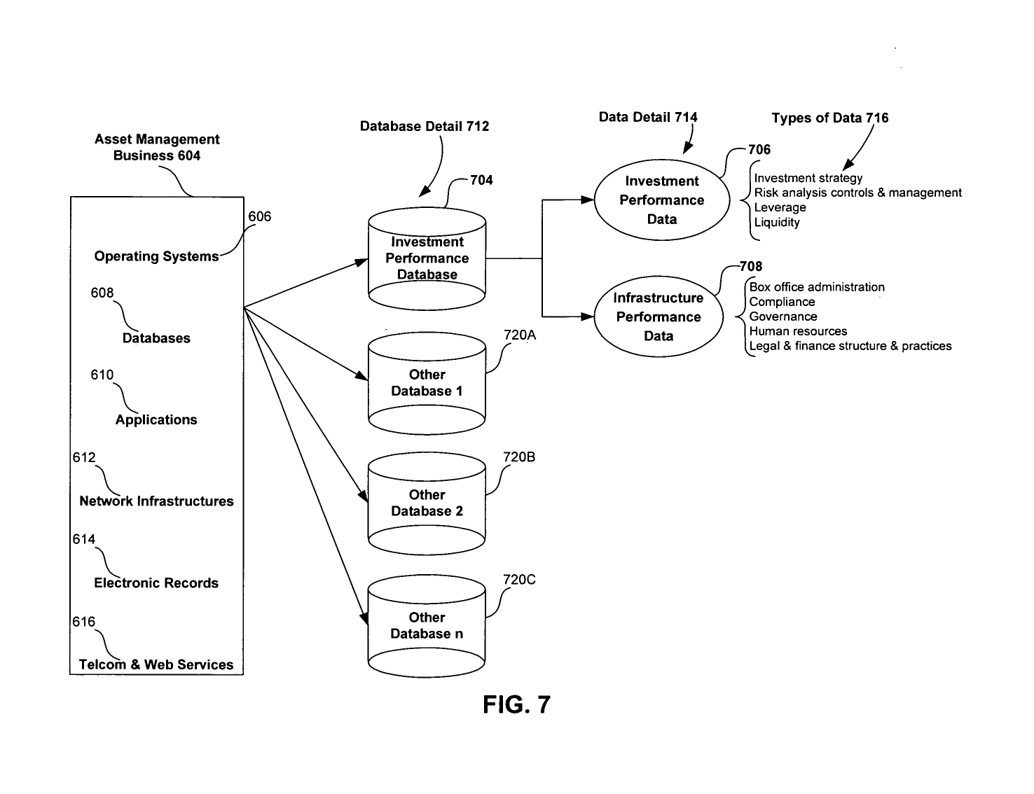

For example, FIG. 7 illustrates example data types from an example database of an asset management business 702. More specifically, investment experiential data 706 extracted from an investment performance database 704 relates to investment strategy, risk analysis, controls and management, leverage and liquidity management. Infrastructure experiential data 708 relates to back office operations and administration, compliance, governance, human resources, legal and financial structure and practices. The inventive method applies a set of metrics and algorithms to experiential data related to these types of data to measure how well the investment and infrastructure functions and activities are performing. This example database is provided solely for purposes of illustration, and are not limiting.

FIG. 2 broadly illustrates the operation of an asset management business rating system according to an embodiment of the invention, working from the bottom of the middle column of the diagram to the top. The column on the left 202 represents the metrics 208 which are applied to the extracted experiential data to measure the performance of the functions and activities supporting the business. These inventive measures 208 may be expressed as values or graded categories. The column to the right 206 represents the algorithms 254 which analyze and interpret the measures 208 to determine how well and the asset management business is performing and to compute an overall rating for the asset management business. The example operation depicted in FIG. 2 shall now be described in greater detail with reference to the operational flowchart 302 of FIG. 3 and the example data flow diagrams of FIGS. 4A-4F.

As previously mentioned, the first step is to extract experiential (or source) data 240 (this is performed in step 304 of FIG. 3). Examples of the services (business processes), functions and activities of an asset management business generating the experiential data as well as the applications and databases systems primarily involved in handling and storing the experiential data of an asset management business are listed in Tables 1 and 2, above.

Referring to the example of FIG. 4A, experiential data 410, 418 is generated when the services (business processes) related to the investment functions 406 and infrastructure functions 414 and associated activities 408, 416 are performed. Experiential investment data 410 would include, but not be limited to, investment performance returns. Experiential infrastructure data 418 would include data about the data, for example, source verification data related to the investment performance returns. Such experiential data is collected in this first step 304. An example of data about the data would be the time and data stamp data assigned by the computer in the course of performing a business process. For example, when buying a security, an order management system time and data stamps the order to buy at various points in time, for example, when the order is first introduced to the system, when it is executed and when the order is allocated. This data that is created by the infrastructure (i.e., the systems and network operations) in the course of performing the business processes fueling the functions and activities of the business, is an additional source of experiential data.

Examples of experiential investment and infrastructure data is detailed in Table 3. The example of Table 3 is provided solely for purposes of illustration, and is not limiting.

TABLE 3
Examples Of Experiential Investment And Infrastructure Data

| Experiential Investment Data 410 | Experiential Infrastructure Data 418 |
|---|---|
| Investment performance returns | Data source verification |
| time period detail | Data delivery methodology |
| individual funds/portfolio detail | Data timeliness |
| composite portfolio detail | Data accuracy |
| assets under management | Data completeness |
| Risk analysis | Data security |
| Scenario analysis | Efficiency of extraction process |
| Supporting transactional detail | Level of required customization |

Asset management businesses often rely on agents to maintain the books and records of their business. In so doing, some of the services (business processes) involved in the functions and activities of the business are executed by the agent on behalf of the asset manager. As a result, experiential data related to the investment and infrastructure functions and activities of the business resides on the operating systems, databases, applications, network infrastructure of the agent. An alternative embodiment of the present invention includes extracting the asset manager's experiential data from such an agent, for example, an investment bank (prime broker), custodian, fund administrator, fund-of-funds, consultant or other service provider using the inventive method as described. An example extraction algorithm is shown as 422 in FIG. 4A.

In an embodiment, the extraction algorithm is a set of pre-determined instructions designed for the extraction of specific data and executed by a computer program. These instructions include well-defined requests for each data set required. Data, such as, investment performance results would include such specifications as time period and name of portfolio results being requested. The instructions would also detail how the data request is made, where the request is directed and what constitutes finding and extracting it satisfactorily.

The next step is to verify the integrity of the data (step 306). Inventive verification metrics and algorithms 428 are applied to the extracted experiential data 424 to confirm its source and the integrity of the extraction process 422 by applying built-in logic, control checks and audit log verification.

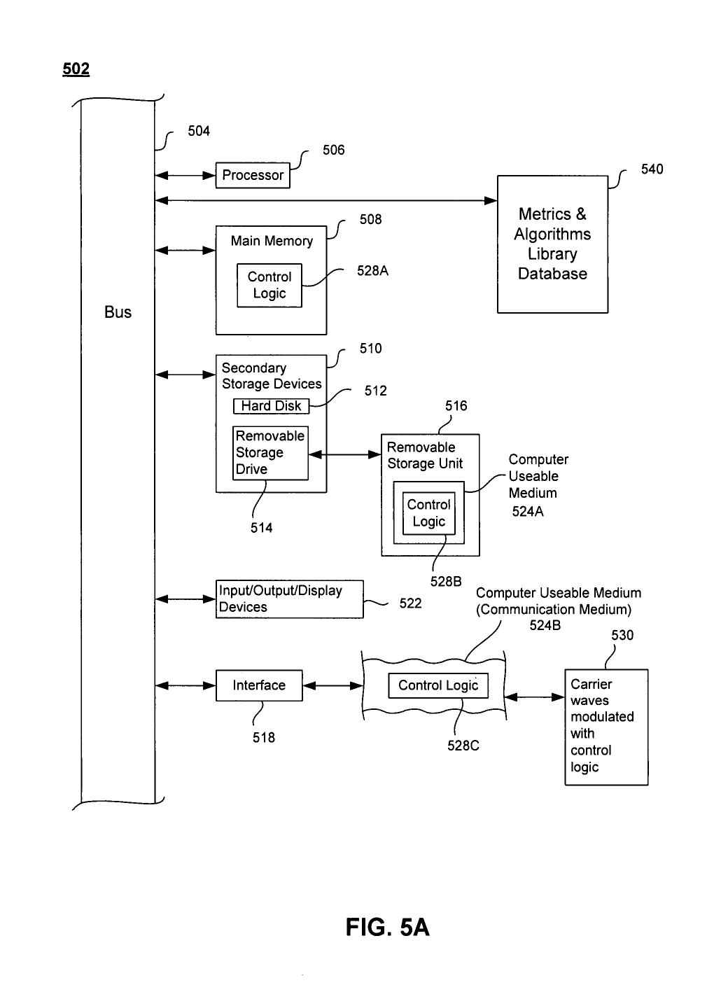

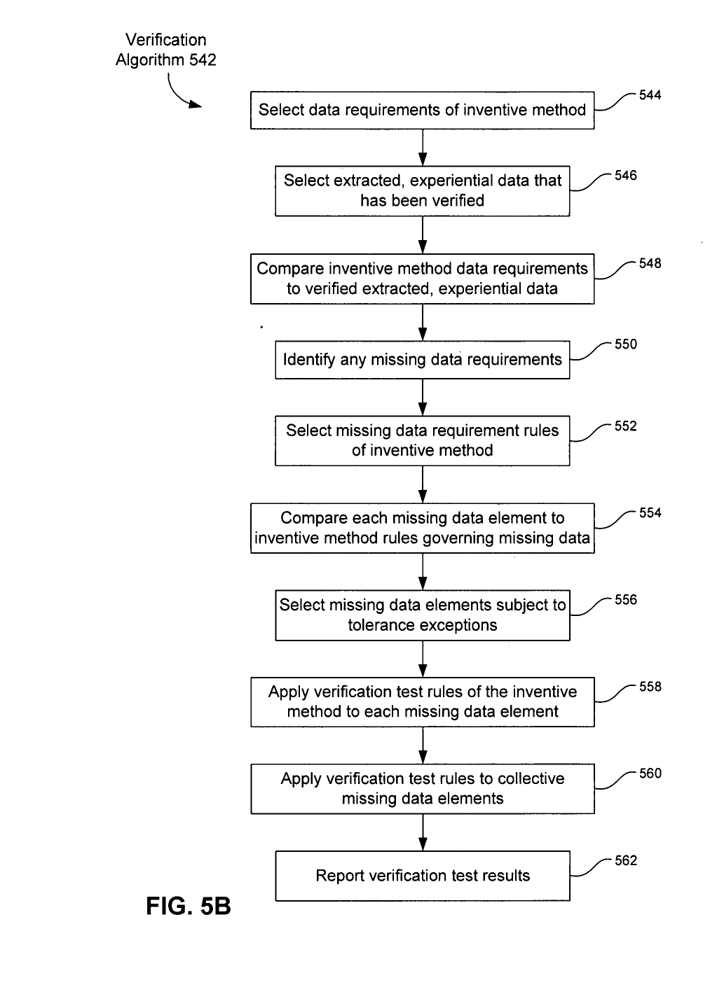

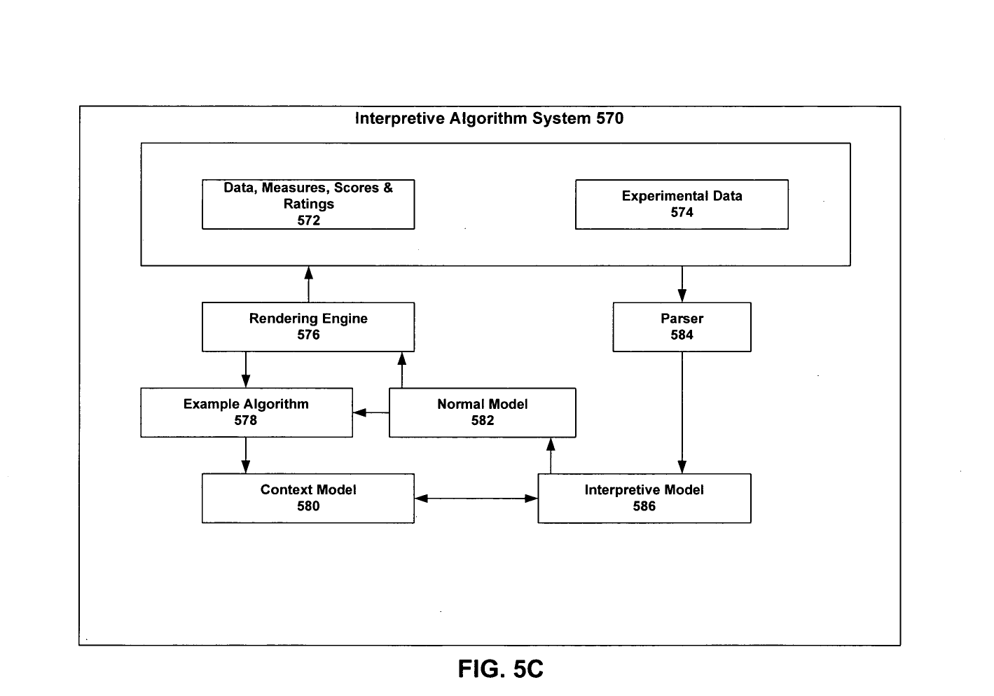

FIG. 5A is an example computer implementation of the inventive method. In FIG. 5A, an example database 540 of metrics and algorithms of the inventive method is shown. In step 306, a verification algorithm 428 is applied to the extracted data 424 to determine, for example, whether all of the data required by the inventive method has been extracted. In an embodiment, to make this determination, the algorithm 428 compares the data extracted 424 to the data requirements of the inventive method. The algorithm 428 identifies any missing data elements and then applies pre-set inventive rules pertaining to missing data, including tolerance guidelines. The algorithm 428 then applies an inventive verifications test to each missing data element to determine whether any individual missing data element would precipitate a failed verification test. If none of the missing data elements individually causes a failed verification test, then the inventive algorithm 428 applies an inventive, pre-determine verification test to the collective missing data elements.

An example verification algorithm 428 is illustrated in FIG. 5B, which shall now be described. In step 544, data requirements are selected (the requirements may be pre-selected, and/or input/revised by an operator). In step 546, extracted, experiential data 424 is selected. In step 548, the data requirements are compared to the extracted, experiential data 424. In step 550, any missing data requirements are identified. In step 552, missing data requirement rules are selected. In step 554, each missing data element is compared to the selected rules governing missing data.

These rules define the actions to be taken when a requested data element has not been supplied. For example, if investment performance results had been requested for three time periods but data only for two time periods was supplied, rules are applied to the condition when investment performance results are not supplied for a time period requested. The rules dictate the sequence of activity to be taken under this condition. An example sequence of activities includes 1) requesting the data again; 2) sending an alert notification and 3) logging the data request failure.

In step 556, missing data elements that are subject to tolerance exceptions are selected.

A tolerance exception occurs when a data request has been made and the data has been supplied in response to the request, yet there is a variance between the data requested and the data supplied. The variance results in an exception. Exceptions are subjected to tolerance tests to determine the magnitude of the variance and ultimately, whether the data request has been satisfied.

An example of a tolerance exception is illustrated by the condition of a request for data related to investment performance results requiring the supply of the investment performance results to three decimal places yet data is supplied only to two decimal places. A tolerance test is applied to the exception to determine whether data to two decimal places is satisfactory or not.

In step 558, verification test rules are applied to each missing data element. In step 560, verification test rules are applied to collective missing data elements.

Verification rules apply to the integrity of the data. For example, its source and the methodology used in obtaining it. Verification rules determine, for example, whether the data was extracted directly from a designated source system or whether it was supplied by manual intervention.

In step 562, verification test results are reported.

The inventive method performs the verification process 428 to derive additional experiential infrastructure data 418 related to the asset management business being evaluated as discussed in above. This step is illustrated in FIG. 4B

An example of experiential data created in the verification process is the time, date and duration of the verification process. Such data provides a quantitative framework to identify and understand data integrity issues.

Data is easily compromised in the asset management industry owing to lack of standard data models, communication protocols and widespread disparate systems and legacy technology issues. Data integrity is further pressured by the complexity of the source data, i.e., the security instruments and the transaction types involved. The inventive method is designed to glean information about the asset manager's business processes related to ensuring the integrity and security of its data.

The next step is to compute measures (step 308). In the example of FIG. 4C, measuring metrics and algorithms 436 are applied to the verified experiential data 430, 432 to compute investment and infrastructure measures 438, 440. These measures, or criteria, may be expressed as values or graded categories.

Measures are calculated to understand how well the business processes fueling the activities and functions of the business are performing. A pre-determined set of measures is applied to experiential data generated by the business processes of the activities and functions of the business. For example, trade capture is an activity of the operations functions as illustrated in Table 1. An exemplary measure of how well the trade capture activity is performing can be measured by computing the percent of trades captured on-time. Continuing the example of measuring trade capture performance, an exemplary measurement algorithm is used to evaluate the trade capture activity overall. This measure involves compiling various measures and using simple math to combine them to produce a representative summary activity measure of performance, such as the percent of trades captured on-time, error-free, and electronically.

The next step is to analyze the measures (step 310). In the inventive method, the measures are weighted by their importance to the business by an inventive analytic algorithm 444. Weightings are determined by a set of metrics and algorithms 444 designed to account for the interdependencies of the business processes of the functions and activities and their corresponding importance on each other and the business overall. In the example embodiment of FIG. 4D, this step is achieved by averaging and weighting the previously determined measures 438, 440.

Other embodiments of the invention include analytic metric and algorithms as simple as to compare the measures to prior time periods and as complex as to analyze them for consistency and/or insight into investment skill, business soundness and risk discipline.

Another embodiment of the invention is to utilize metrics and algorithms 444 to analyze the measures by establishing a baseline of investment and infrastructure performance for the asset management business being evaluated. Additional metrics and inventive algorithms 444 are applied to compute “normal” and “actual” measures. Normal measures relate to objectives set by the business to achieve on behalf of its clients. In other applications of the analytic metrics and algorithms, normal measures relate to a baseline of investment and infrastructure performance for the asset management business being evaluated. A baseline is established by averaging a time series of measures to compute normal measures. Actual measures, the realized investment and infrastructure performance measures, are then compared to the baseline.

For example, an asset management business may represent to a client that it has an investment objective of returning 8% per annum. Therefore, the normal measure of investment performance of the example business would be 8%. This is compared to the actual investment performance of the business at year-end. These serves as additional investment performance analytic measures to be used in the evaluation, scoring and rating of an asset management business.

A normal infrastructure measure, for example, is a 95% settlement rate on all security transactions for the business. In other words, the business averages a 95% settlement rate on all security transactions, which is a measure of its infrastructure performance. Periodic measurements of the business' settlement rate is compared to its baseline rate of 95%. These measures serve as additional infrastructure performance measures to be used in the evaluation and rating of an asset management business.

Furthermore, these measures described above are used to objectively, automatically and quantitatively assess the consistency of the performance of the investment and infrastructure services (business processes) of an asset management business. These measures are also used to assess the effectiveness of the asset management business in terms of achieving its stated objectives by quantitatively comparing objectives to results. This allows an asset management business to establish its own investment and infrastructure performance standards to be measured against.

The next step is to score the investment and infrastructure services (business processes) (step 312). The weighted measures 438, 440 are combined to produce scores 446, 448 that quantitatively represent the effectiveness of the investment and infrastructure services (business processes). Scoring algorithms 445 take the weighted measures 438, 440 and first compare them to a baseline of corresponding measures previously derived in other time periods. Pre-determined credits are given for measures that have improved and pre-determined debits are given for measures that have underperformed. In this way, the inventive method provides a quantitative framework to easily identify and quantify performance contributors or detractors.

The next step is to interpret the data, measures and scores (step 314). In the inventive method, an inventive algorithm 452 is used to assess the impact of current data 430, 432, measures 438, 440 and scores 446, 448 on the investment and infrastructure services (business processes). The inventive algorithm 452 is designed to factor the degree of impact of the changes in the data 430, 432, measures 438, 440, and scores 446, 448 on the performance of the investment and infrastructure services (business processes). The inventive algorithm 452 also draws from the weightings assigned in the previous step.

With respect to step 314, an embodiment of the invention is the interpretation of investment and infrastructure data, measures and scores against a changing context. The interpretive algorithms are designed to create and maintain models of the evolving performance of an asset management business. The data structures (i.e., context models) of the algorithms contain the data, measures and scores and their associated properties available for reference. In the data structures (context models) new data, measures and scores are compared to existing data, measures and scores.

For example, a data structure (context model) for data related to the trade settlement activity of the operations function includes the number of trades settled in the current period. An example interpretive algorithm compares the number of trades settled in the current period data structure to a normal period data structure comprised of the average number of trades settled in previous, similar time periods. The trade settlement data structure also includes other information that can be factored into the comparison process by the inventive algorithm, such as the degree of importance any change in settlement rate would have 1) on the operation function and 2) on the operation of the asset management business.

An example of a data structure (context model) for measures related to the trade settlement activity of the operation function includes the frequency of an on-time settlement rate in the current period. An example interpretive algorithm compares the frequency of an on-time settlement rate to, for example, changing trade volumes and security complexity to measure the impact of trading activity dynamics on the operational performance of the infrastructure of an asset management business.

An example of a data structure (context model) for a score related to the trade settlement activity of the operation function includes combining multiple factors, such as the scores of the related business processes, activities and functions of the asset management firm necessary to project the impact of current performance on the objectives of the asset management business. A mechanism for modeling the impact of current performance is another component of the example inventive algorithm.

Data structures (context models) are updated in the inventive method as a result of events such as data extraction or data verification. Multiple types of information are stored in data structures (context models) in order to facilitate comparison interaction and to provide local interpretive contexts for each event.

An interpretive algorithm system 570 for performing the operation described above is illustrated in FIG. 5C. To illustrate, an exemplary interpretive algorithm related to trade settlement will be discussed in the context of FIG. 5C.

An embodiment of an exemplary interpretive algorithm related to trade settlement begins with experiential data 574 collected as described above, such as the number of trades settled in the current period, current trading volume, assets under management, number of each security type traded in current period and the number of each transaction type executed in the period. Experiential data 574 is then input into the parser 584 which transforms the trade settlement data into data structures designed to organize the hierarchy of the trade settlement data elements in relation to each other. The parsed information is then sent to the interpretive model 586 which puts the new trade settlement information into context for analysis. Information flows between the interpretive model 586 and the context model 580 to facilitate the interpretation of the trade settlement information. For example, the context model 580 models the effect of current trade settlement information on various performance interpretive parameters, such as the impact of declining trade settlement effectiveness on infrastructure performance. Information also flows from the interpretive model 586 to the normal model 582. The normal model 582 structures historical (or baseline) trade settlement information. The inventive algorithm 578, for example, analyzes the trade settlement information to determine the persistence of the declining trade settlement effectiveness and the impact on infrastructure performance. Information flows from the normal model 582 into the rendering engine 576 which formats and displays the interpreted trade settlement information 572.

The next step is to rate investment and infrastructure performance (step 316). An inventive algorithm 453 combines the data 430, 432, measures 438, 440 and scores 446, 448 for the investment and infrastructure services (business processes) to quantitatively express the indicative level of investment and infrastructure performance 454, 456.

One component of the inventive rating algorithm 453 involves the determination of directionality in the data, measures and scores of the investment and infrastructure services (business processes). Data, measures and scores are sorted in chronological order to determine how these indicators of performance impact the asset management business (i.e., favorably or not) both in the current time period perspective as well as how they might impact the asset management business in future time periods should performance persist. A set of rules to infer the nature and severity of change in data, measures and scores involves comparing changes in the current period with the experiential impact of similar change dynamics conditions in prior periods. The degree of change in the data, measures and scores are measured and weighted for the their specific and collective impact on the current and future operation of the asset management business. Pre-determined values are added or deducted from the weightings according to their importance and potential impact.

The next step is to interpret the investment and infrastructure performance ratings (step 318). In this step, an inventive interpretive algorithm 460 expressly designed to interpret the investment and infrastructure performance ratings 454, 456 is used to interpret the implications of changes on the operation of the asset management business and to put the ratings into context.

For example, an inventive algorithm 460 interprets the investment and infrastructure ratings in the context of other selected business dynamics such as the impact of directionally decreasing infrastructure performance in the trade settlement function as trading volume is directionally increasing and investment performance is flat. In this example, the modeling mechanism of the inventive algorithm 460 analyzes a pre-determined series of experiential and projected scenarios involving trade settlement operations, trading volume and investment performance. The inventive algorithm 460 identifies key determinants in various experiential scenarios and quantitatively rates the determinants by their potential impact based on experiential data. The quantified determinants are then weighted by their importance and degree of interdependency and utilized by the inventive algorithm 460 to put the ratings into context both in relative and objective terms based on the experience of the asset management business.

The next step is to rate the asset management business (step 320). The method culminates in rating the asset management business by factoring the investment and infrastructure performance ratings 454, 456 together, the process of which involves using an inventive rating algorithm 461 designed to evaluate and quantify the level of performance of the asset management business using data 430, 432, measures 438, 440, scores 446, 448, ratings 454, 456 and additional algorithmic interpretive information derived in previous steps (steps 308, 310, 312, 314, 316, and/or 318).

The inventive method relies on computers to execute a series of algorithms that incorporate previously calculated metrics and algorithmic analyses and interpretations. The inventive algorithm 461 identifies key determinants in various experiential scenarios and quantitatively rates the determinants by their potential impact based on experiential data. The quantified determinants are then weighted by their importance and degree of interdependency and utilized by the inventive algorithm 461 to combine and calculate the values assigned to the metrics, analyses and ratings in order to compute a rating for the asset management business.

For example, in the current measurement period, assume all of the current measures, scores and interpretive analysis indicate that infrastructure performance is comparable across all key determinants of baseline performance, however, two components of investment performance are below the baseline. In an embodiment, an interpretive algorithm analyzes past results involving the two components of investment performance and finds that they are key determinants of investment performance and therefore weights them heavily in the calculation of the rating of the asset management business.

It is noted that, in the above description, references to “algorithm” or “algorithm” may correspond to software and/or hardware modules.

Example Computer Implementation

In an embodiment of the present invention, the system and components of the present invention described herein are implemented using well known computers, such as computer 502 shown in FIG. 5.

The computer 502 can be any commercially available and well known computer capable of performing the functions described herein, such as computers, as well as any other data processing device available from International Business Machines, Apple, Sun, HP, Dell, Compaq, Digital, Cray, etc.

The computer 502 includes one or more processors (also called central processing units, or CPUs), such as a processor 506. The processor 506 is connected to a communication bus 504.

The computer 502 also includes a main or primary memory 508, such as random access memory (RAM). The primary memory 508 has stored therein control logic 528A (computer software), and data.

The computer 502 also includes one or more secondary storage devices 510. The secondary storage devices 510 include, for example, a hard disk drive 512 and/or a removable storage device or drive 514, as well as other types of storage devices, such as memory cards and memory sticks. The removable storage drive 514 represents a floppy disk drive, a magnetic tape drive, a compact disk drive, an optical storage device, tape backup, etc.

The removable storage drive 514 interacts with a removable storage unit 516. The removable storage unit 516 includes a computer useable or readable storage medium 524 having stored therein computer software 528B (control logic) and/or data. Removable storage unit 516 represents a floppy disk, magnetic tape, compact disk, DVD, optical storage disk, or any other computer data storage device. The removable storage drive 514 reads from and/or writes to the removable storage unit 516 in a well known manner.

The computer 502 also includes input/output/display devices 522, such as monitors, keyboards, pointing devices, etc.

The computer 502 further includes a communication or network interface 518. The network interface 518 enables the computer 502 to communicate with remote devices. For example, the network interface 518 allows the computer 502 to communicate over communication networks or mediums 524B (representing a form of a computer useable or readable medium), such as LANs, WANs, the Internet, etc. The network interface 518 may interface with remote sites or networks via wired or wireless connections.

Control logic 528C may be transmitted to and from the computer 502 via the communication medium 524B. More particularly, the computer 502 may receive and transmit carrier waves (electromagnetic signals) modulated with control logic 530 via the communication medium 524B.

Any apparatus or manufacture comprising a computer useable or readable medium having control logic (software) stored therein is referred to herein as a computer program product or program storage device. This includes, but is not limited to, the computer 502, the main memory 508, the secondary storage devices 510, the removable storage unit 516 and the carrier waves modulated with control logic 530. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method of evaluating and rating an asset management business, comprising:
extracting experiential data;
verifying data integrity;
computing measures;
analyzing measures;
scoring investment and infrastructure functions;
interpreting data, measures and scores;
rating investment and infrastructure performance;
interpreting investment and infrastructure performance; and
rating said asset management business.

2. The method of claim 1, wherein said experiential data comprises data that is generated in the course of performing functions and activities related to said asset management business.

3. The method of claim 1, wherein said verifying step comprises:
confirming source and integrity of said extracting step.

4. The method of claim 1, wherein said computing measures step comprises:
computing investment and infrastructure measures to determine how well the business processes fueling activities and functions of said asset management business are performing.

5. The method of claim 4, wherein said analyzing measures step comprises:
weighting said investment and infrastructure measures by their importance to said asset management business.

6. The method of claim 5, wherein said scoring investment and infrastructure functions step comprises:
generating scores from said weighted investment and infrastructure measures, wherein said scores quantitatively represent effectiveness of investment and infrastructure services of said asset management business.

7. The method of claim 1, wherein said interpreting data, measures and scores step comprises:
assessing impact of experiential data, measures, and scores on investment and infrastructure services of said asset management business.

8. The method of claim 1, wherein said rating investment and infrastructure performance step comprises:
combining experiential data, measures, and scores for investment and infrastructure services to quantitatively express an indicative level of investment and infrastructure performance of said asset management business.

9. The method of claim 1, wherein said interpreting investment and infrastructure performance step comprises:
interpreting investment and infrastructure performance ratings to interpret implications of changes on operation of said asset management business.

10. The method of claim 1, wherein said rating said asset management business step comprises:
rating said asset management business by factoring together investment and infrastructure performance ratings.

11. A computer program product comprising a computer useable medium having computer program logic recorded thereon for enabling a processor to evaluate and rate an asset management business, the computer program logic comprising:
first means for enabling a processor to extract experiential data;
second means for enabling a processor to verify data integrity;
third means for enabling a processor to compute measures;
fourth means for enabling a processor to analyze measures;
fifth means for enabling a processor to score investment and infrastructure functions;
sixth means for enabling a processor to interpret data, measures and scores;
seventh means for enabling a processor to rate investment and infrastructure performance;
eighth means for enabling a processor to interpret investment and infrastructure performance; and
ninth means for enabling a processor to rate said asset management business.

12. The computer program product of claim 11, wherein said experiential data comprises data that is generated in the course of performing functions and activities related to said asset management business.

13. The computer program product of claim 11, wherein said second means comprises:
means for enabling a processor to confirm source and integrity of said extracting step.

14. The computer program product of claim 11, wherein said third means comprises:
means for enabling a processor to compute investment and infrastructure measures to determine how well the business processes fueling activities and functions of said asset management business are performing.

15. The computer program product of claim 14, wherein said fourth means comprises:
means for enabling a processor to weigh said investment and infrastructure measures by their importance to said asset management business.

16. The computer program product of claim 15, wherein said fifth means comprises:
means for enabling a processor to generate scores from said weighted investment and infrastructure measures, wherein said scores quantitatively represent effectiveness of investment and infrastructure services of said asset management business.

17. The computer program product of claim 11, wherein said sixth means comprises:
means for enabling a processor to assess impact of experiential data, measures, and scores on investment and infrastructure services of said asset management business.

18. The computer program product of claim 11, wherein said seventh means comprises:
means for enabling a processor to combine experiential data, measures, and scores for investment and infrastructure services to quantitatively express an indicative level of investment and infrastructure performance of said asset management business.

19. The computer program product of claim 11, wherein said eighth means comprises:
means for enabling a processor to interpret investment and infrastructure performance ratings to interpret implications of changes on operation of said asset management business.

20. The computer program product of claim 11, wherein said ninth means comprises:
means for enabling a processor to rating said asset management business by factoring together investment and infrastructure performance ratings.
